(19) United States
(12) Patent Application Publication
(10) Pub. No.: US 2024/0207782 A1
(43) Pub. Date: Jun. 27, 2024

(54) SENSOR BASED AIR TREATMENT CONTROL

(71) Applicant: Scott A. Elrod, Lake Jackson, TX (US)

(72) Inventor: Scott A. Elrod, Lake Jackson, TX (US)

(21) Appl. No.: 18/146,615

(22) Filed: Dec. 27, 2022

(51) Int. Cl. B01D 53/34; A23B 7/152; B01D 53/72; B01D 53/76

(52) U.S. Cl. CPC B01D 53/346; A23B 7/152; B01D 53/72; B01D 53/76

(57) ABSTRACT

Embodiments of the invention relate to devices, systems, and methods utilizing air treatment devices having an air treatment source, a controller operably coupled to the air treatment source and configured to control output of air treatment from the air treatment source, and at least one sensor operably coupled to the controller, to provide air treatment into enclosed spaces according to sensed conditions.

### BACKGROUND

During transit or non-use, the contents of containers, rooms, or other enclosures may rot, decay, grow bacteria, grow fungi, desiccate, dampen or otherwise change state. The state of the contents may be preserved by wrapping the individual items or by otherwise protecting the items using one or more techniques. The conditions around the contents and enclosures may cause the state of the contents to change. For example, heat may cause food to rot. Humidity may cause wood products to delaminate or linens to stain. Typically passive measures are taken to address conditions around contents of enclosures such as refrigeration, desiccants, coatings, packaging, or the like. However, such measures may be time, cost, and labor intensive.

### SUMMARY

Embodiments of the invention relate to devices, systems, and methods for air treatment in enclosed spaces that utilize sensed air conditions to determine, generate, and output the air treatments within the enclosed spaces.

In an embodiment, a device for controlling contents of air in an enclosed space is disclosed. The device includes an air treatment source. The device includes a controller operably coupled to the air treatment source and configured to control output of air treatment from the air treatment source. The controller of the device includes a memory storage medium having one or more operational programs including machine readable and executable instructions for controlling generation and output of air treatment from the air treatment source. The controller of the device includes a processor operably coupled to the memory storage medium, the processor being configured to read and execute the one or more operational programs. The device includes at least one sensor in electronic communication with the controller, the at least one sensor being configured to detect one or more of temperature, humidity, or concentration of one or more chemicals in an area near or immediately surrounding the device. The one or more operational programs include instructions to control air treatment output to selectively control a state of a good in the enclosed space.

In an embodiment, a system for controlling contents of air within one or more enclosed spaces is disclosed. The system includes one or more air treatment devices, the one or more air treatment devices including an air treatment source, a controller operably coupled to the air treatment source and configured to control output of air treatment from the air treatment source, at least one integrated sensor in electronic communication with the controller, and at least one external sensor in electronic communication with the controller of the air treatment device and disposed outside of the enclosed space. The controller includes a memory storage medium having one or more operational programs including machine readable and executable instructions for controlling generation and output of air treatment from the air treatment source. The controller includes a processor operably coupled to the memory storage medium, the processor being configured to read and execute the one or more operational programs. The at least one integrated sensor is configured to detect one or more internal conditions of an enclosed space in which an air treatment device of the one or more air treatment devices is located. The at least one external sensor is configured to detect one or more environmental conditions of outside of the one or more enclosed spaces. The one or more operational programs include instructions for controlling air treatment output to selectively control a state of a good in the enclosed space according to the one or more environmental conditions and the one or more internal conditions.

In an embodiment, a method of controlling contents of air in one or more enclosed spaces is disclosed. The method includes outputting air treatment into one or more enclosed spaces from one or more air treatment devices disposed therein at a first air treatment rate. Each of the one or more air treatment devices includes an air treatment source, a controller operably coupled to the air treatment source and configured to control output of air treatment from the air treatment source, at least one sensor in electronic communication with the controller. The controller includes a memory storage medium having one or more operational programs including machine readable and executable instructions for controlling generation and output of air treatment from the air treatment source. The one or more operational programs include instructions for controlling air treatment output to selectively control a state of a good in an enclosed space of the one or more enclosed spaces. The controller includes a processor operably coupled to the memory storage medium, the processor being configured to read and execute the one or more operational programs. The at least one sensor is configured to detect one or more of temperature, humidity, or concentration of one or more chemicals in an area near or immediately surrounding an air treatment device of the one or more air treatment devices. The method includes detecting one or more internal conditions within the enclosed space with the at least one sensor. The method includes automatically adjusting generation and output of the air treatment from the air treatment source to a second air treatment rate that differs from the first air treatment rate in one or more of temperature, humidity, or oxidant output, responsive to detecting one or more internal conditions within the enclosed space.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is a block diagram of an air treatment device for controlling contents of air in an enclosed space, according to an embodiment.

FIG. 2 is an isometric view of the air treatment device, according to an embodiment.

FIG. 3 is an isometric view of an enclosed space having an air treatment device disclosed therein, according to an embodiment.

FIG. 4 is a block diagram of a system for controlling contents of air within one or more enclosed spaces, according to an embodiment.

FIG. 5 is a block diagram of a system for controlling contents of air within one or more enclosed spaces, according to an embodiment.

FIG. 6 is a block diagram of a system for controlling contents of air within one or more enclosed spaces, according to an embodiment.

FIG. 7 is a flow diagram of a method for controlling contents of air in one or more enclosed spaces, according to an embodiment.

### DETAILED DESCRIPTION

Embodiments of the invention relate to devices, systems, and methods for air treatment in enclosed spaces that utilize sensed air conditions to determine, generate, and output the air treatments within the enclosed spaces. The air treatment devices include an air treatment source, a controller operably coupled to the air treatment source, and at least one sensor operably coupled to the controller. The air treatment device is disposed at least partially within an enclosed space. The air treatment devices utilize sensor data from the at least one sensor to monitor environmental conditions outside of the enclosed space(s) and internal conditions within the corresponding enclosed space. The sensor data indicating the conditions is used to determine, set, generate, and output air treatment into the enclosed space. The air treatment may be formulated to control the state of a good within the enclosed space, such as ripeness or freshness of food, sanitization of goods, water content of wood or fibers, or any other state of a good. For purposes of this disclosure, a good or object can be any item or object capable of placing inside an enclosed space, where the state or composition of the good can be altered by the air surrounding the good inside the enclosed space or by air an area near or immediately surrounding the device.

Air treatment systems disclosed herein utilize at least a single external sensor to detect environmental conditions for multiple air treatment devices disposed in multiple enclosed spaces. The systems can utilize sensors on the air treatment devices to determine one or more internal conditions with the respective enclosed spaces. The controllers of the air treatment devices can be used to selectively control (e.g., customize) air treatment in the respective enclosed spaces, based at least in part on the sensor data. Methods of treating air in enclosed spaces can be used to control the state of goods in the enclosed spaces.

The devices, systems, and methods for air treatment in enclosed spaces disclosed herein can be used to control the state of any goods or objects within the enclosed spaces, such as fruits, vegetables, meat, packages, wood products, fibers, etc. The enclosed spaces may include cargo containers, train cars, truck trailers, hotel rooms, hospital rooms, school rooms, refrigerators, offices, or any other enclosed spaces. For example, the devices, systems, and methods for air treatment in enclosed spaces disclosed herein may be used to provide air treatment to multiple cargo containers on a cargo ship. In such examples, the power cords provided to the containers from the ship may power the air treatment devices. Data cords or connections may be provided to the cargo containers as well.

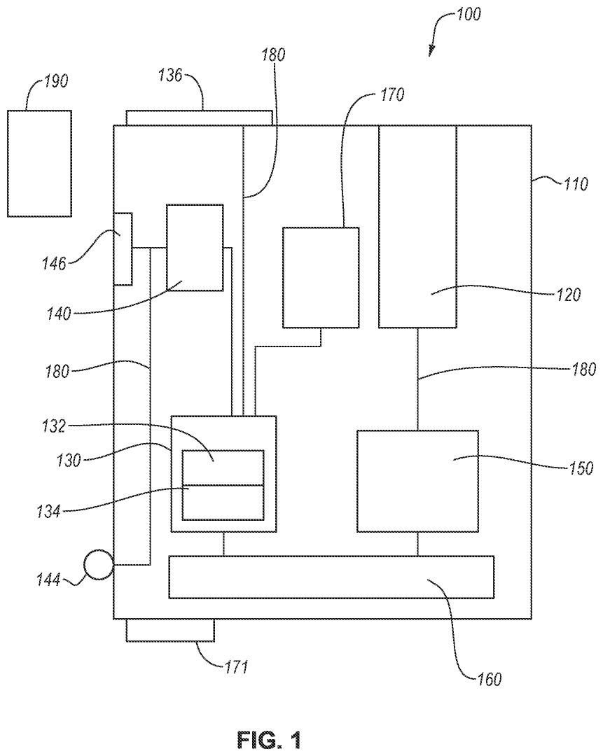

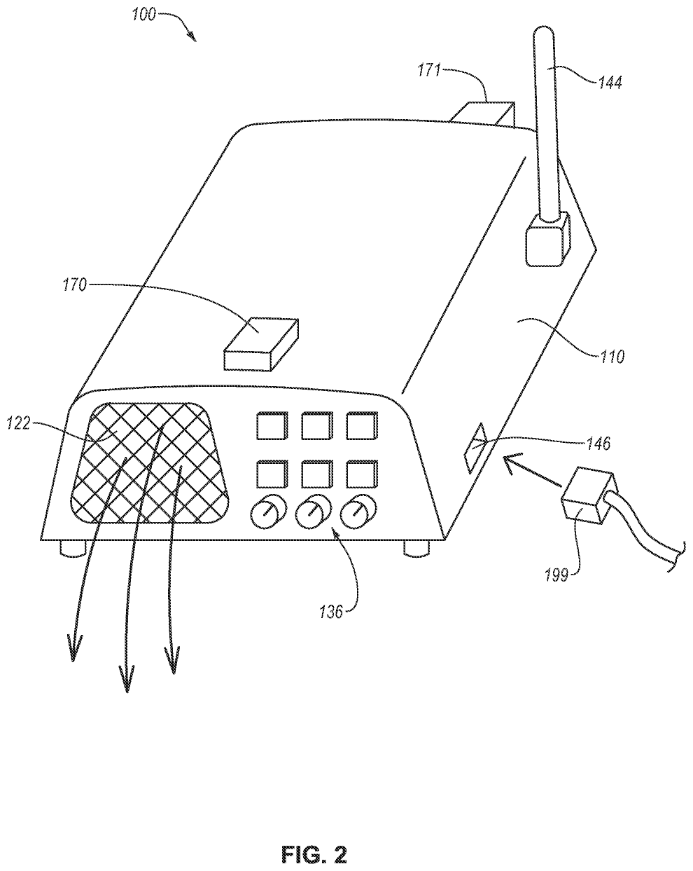

FIG. 1 is a block diagram of an air treatment device 100 for controlling contents of air in an enclosed space, according to an embodiment. FIG. 2 is an isometric view of the air treatment device 100, according to an embodiment. The air treatment device 100 includes a housing 110; an air treatment source 120; a controller 130 configured to control treatment output from the air treatment source 120; a communication hub 140 configured to receive one or more signals from other air treatment devices, central hubs, or sensors; one or more fans 150; a power source 160; and at least one sensor 170-171. The components of the air treatment device 100 are electrically connected via circuitry 180. The air treatment device 100 may include a remote control 190 to control one or more operations thereof.

The housing 110 includes a framework for storing components of the air treatment device 100. The housing 110 is sized and shaped to contain the components of air treatment device 100. For example, the air treatment source 120, the controller 130, the communication hub 140, the fan 150, the power source 160, the at least one sensor 170-171, and the circuitry 180 may be at least partially disposed within or on the housing 110. The housing 110 may be constructed of one or more of metals, polymers, composites (e.g., carbon fiber), ceramics, or the like.

The housing 110 may include an outlet 122 for the air treatment to pass through. For example, the outlet 122 may be a grate, screen, or other body for air treatment material (e.g., ozone, ions, scent material, heated air, cooled air, humidity) to pass through. In some examples, the housing 110 may include a plurality of outlets 122 such as one or more of an intake grate, a cooling grate, or other grates (not shown). For example, an intake grate may be located on a back, bottom, or top surface of the housing 110 to draw air into the fan 150 and/or the air treatment source 120.

The housing 110 may include legs for creating a space between the housing and a surface upon which the air treatment device 100 is mounted. In some examples, the housing may include a mounting bracket, fixture, or structure for mounting the air treatment device 100 on or in a wall or ceiling of the enclosed space.

The air treatment source 120 is configured to provide air treatment into an enclosed space, such as to clean, heat, cool, humidify, dehumidify, remove (e.g., react with) one or more chemicals, to control the state of one or more goods (e.g., objects) in the enclosed space. For example, the air treatment device 100 may include one or more of an ozone generator, an ion generator, an ultraviolet light source, an anti-microbial source, a humidifier, a dehumidifier, a heater, a cooler, an air filter, or the like. Accordingly, the air treatment source 120 may be configured to output one or more of ozone, hydroxide ions, hydride ions, a selected chemical, anti-microbial material, heat, cooling, humidity, dehumidified air, or pure air (without particulates). In some examples, the air treatment source 120 may include an ozone generator and the goods or objects may be fruit, vegetables, meat, dairy, eggs, or other foodstuffs. In such examples, ozone may be output into the enclosed space to react with ethylene from fruit to prevent the fruit from ripening during transit or storage. Ozone output may be terminated if ripening is desired, such as to provide ripe fruit upon delivery of the fruit to a store. Likewise, the temperature, amount of oxygen, or humidity in a container may be reduced to prevent meat from rotting or rust from forming on metal goods.

Suitable ozone generators may include a corona discharge generator, an ultraviolet ozone generator, an electrolytic ozone generator, or the like. Suitable ion generators may include a negative ion generator, a bipolar ion generator, an electrostatic discharge ionizer, or the like. Suitable ultraviolet light sources may include a full spectrum UV light source, a UV-C light source, or another UV light source, such as a bulb or light emitting diode. Suitable anti-microbial sources may include a sprayer, a diffuser, an atomizer or the like. Suitable a humidifiers may include a cool mist humidifier, a warm mist humidifier, an ultrasonic humidifier, an evaporative humidifier, a vaporizer a sprayer (e.g., an aerosol or mist dispenser), a gravity drip diffuser, a nebulizer, an atomizer, or the like. Suitable dehumidifiers may include a refrigerant dehumidifier, a desiccant dehumidifier, or the like. Suitable heaters may include a resistive heater, an induction heater, a flame heater (e.g., kerosene, propane, natural gases, or the like), a ceramic heater, a fluid filled heater (e.g., heated oil or water baffles or tubes), an infrared heater, or the like. Suitable coolers may include evaporative coolers, refrigerated coolers (e.g., mechanical-compression refrigerator, absorption refrigerator, thermoelectric cooler, or the like), or any other type of cooler, refrigerator, or freezer. Suitable air filtration devices may include an air filter, such as an electrostatic air, a HEPA filter, a UV light filter, a media filter, a pleated filter, a spun glass air filter, a washable filter, or the like. In some examples, the air treatment source 120 may include combinations of any of the example air treatment sources disclosed herein, such as a humidifier, dehumidifier, and an ozone generator.

As discuss in more detail below, one or more fans 150 may be used in conjunction with the air treatment source 120 to propel or otherwise output air treatment or air treatment material into the enclosed space.

Particularly effective air treatment sources include ozone sources, such as corona discharge generators or even ion generators. Such air treatment sources provide for fast and effective treatment of an enclosed space including the objects and goods therein. Ozone is particularly effective at reacting with air born molecules to convert the air born molecules into one or more reaction products. For example, the reaction of ozone with ethylene on fruit or vegetables or in the air surrounding the same occurs readily and delays ripening.

Control of the air treatment source 120 may carried out by the controller 130. For example, the controller 130 is configured to control treatment output from the air treatment source 120. The controller 130 includes a memory storage medium 132 storing one or more operational programs thereon, the one or more operational programs including machine readable and executable instructions controlling generation and output of air treatment from the air treatment source 120. The controller 130 includes a processor 134 operably coupled to the memory storage medium 132 and configured to execute the one or more operational programs. For example, the processor 134 may access, read, and execute the one or more operational programs to control output of the air treatment from the air treatment source, communicate with a central sensor hub or additional air treatment devices via the communication hub (e.g., transmit alarm signals) or automatically control any other aspect of operation of the air treatment device 100.

The one or more operational programs may include machine readable and executable instructions for instructions for controlling one or more temperature, chemical concentration (e.g., oxygen, ozone, ethylene), humidity, or particulate concentration within the enclosed space, such as by generating and outputting one or more of any of the foregoing air treatments. The one or more operational programs may include machine readable and executable instructions for generating and outputting air treatment based on sensing data from the at least one sensor 170 or 171. For example, the one or more operational programs may include machine readable and executable instructions for controlling the generation and output of air treatment at a baseline level based on environmental sensing data detected by the external sensor (e.g., at least one sensor 171) and refining the generation and output based internal conditions (indicating by internal sensing data) of the enclosed space as detected by the integrated sensor (e.g., at least one sensor 170) disposed therein. The one or more operational programs may include machine readable and executable instructions for propagating the environmental data from one air treatment device to additional air treatment devices (e.g., via a LAN or wireless connection therebetween).

The air treatment device 100 may include controls 136 (e.g., manual inputs) disposed on the housing 110 or outer surface thereof. The controls 136 are operably coupled to the controller 130 to communicate manual inputs thereto. The controls 136 may include inputs for amount, duration, type, etc. of air treatment. The controls 136 may include inputs for activating the air treatment device. The controls 136 may include inputs for initiating air treatment from the air treatment device. The controls 136 may include inputs for setting fan speed(s), air treatment source operational conditions (e.g., generation and output rates), or the like.

Signals between the remote control 190 and the controller 130, between a central censor hub and the controller 130, between additional air treatment devices and the air treatment device 100, or a wireless network (e.g., Wi-Fi network) are received and sent through the communication hub 140. For example, the communication hub 140 is configured to receive and propagate one or more electronic signals from components of the air treatment device 100 or even outside equipment. The communication hub 140 may be configured to send and receive wireless signals from the central sensor hub or additional air treatment devices. The communication hub 140 may include one or more of a router, transceiver, Bluetooth transmitter and receiver, or the like for wireless communication.

The air treatment device 100 may include a data port 146, such as for a direct connection (e.g., plug-in or hardwired connection) to a central sensor hub or additional air treatment devices. For example, the communication hub 140 may be operably coupled to a data port 146 for hardwired electronic communication, such as a LAN port, USB port, or the like. The data port 146 may also provide power for the air treatment device 100, such as via a connection to the power source 160. The data port 146 may be sized and shaped to connect to a corded connection 199, such as a data and/or power cord. For example, on cargo container ships, a power connection may be provided to cargo containers with air treatment devices 100 therein from the ship's power supply. In such examples, the power connection (e.g., corded connection) may be plugged into the data port 146. In such examples, the data port 146 may alternatively or additionally be configured to supply data, such as environmental data to the air treatment device 100.

As shown, the communication hub 140 may include one or more antennas 144 for receiving and transmitting wireless signals. The antenna 144 may be an external antenna or an internal antenna (e.g., contained within the housing 110). Wireless signals are received by the antenna, processed in the communication hub 140, and may be communicated to the controller 130.

The communication hub 140 may be configured to receive, decode (e.g., read), and transmit electronic signals such hardwired signals or wireless signals. Wireless signals may include one or more of Bluetooth, Wi-Fi, cellular, infrared, radio signals, or the like. The communication hub 140 may be equipped and programmed to wirelessly connect to additional air treatment devices within a wireless communication range of the air treatment device 100. Accordingly, the communication hub 140 may daisy chain a wireless signal to additional air treatment devices, thereby forming a discrete network capable of transmitting wireless signals in locations without a Wi-Fi connection from another source.

The air treatment device may include one or more fans 150. For example, the one or more fans 150 may include a fan 150 for passing ambient air through the treatment source (e.g., over corona discharge coils, through a dehumidifier, through a filter), over the controller or communication hub for cooling, or outputting the air treatment (e.g., propelling ozone, ions, or the like from the housing 110 or treatment source 120). Accordingly, the one or more fans 150 may include a blower, a cooling fan, an intake fan, or combinations of any of the foregoing.

The air treatment device 100 includes a power source 160. The power source 160 may include a power cord, such as a plug-in connection (e.g., three prong 110 volt North American connection, two prong European connection, or the like) for supplying power to the components of the air treatment device 100. The power source 160 may include one or more batteries, such as rechargeable batteries or capacitors. For example, the batteries may be replaceable batteries.

The air treatment device 100 includes at least one sensor 170 and/or 171. The at least one sensor 170 or 171 may include one or more of a temperature sensor, a humidity sensor, an altimeter, a chemical sensor (e.g., an oxidant sensor, an ozone sensor, an oxygen sensor, an ethylene sensor), a particulate sensor, or a global positioning receiver, or the like.

The at least one sensor 170 may be an integrated sensor disposed in the enclosed space, such as in or on one or more portions of the air treatment device 100 disposed in the enclosed space. For example and as shown in FIG. 2, the integrated sensor may be disposed on the housing 110 of the air treatment device 100, such as on the front end region of the air treatment device 100. The integrated sensor may be configured to detect internal conditions of the enclosed space, such as one or more of temperature, concentration of one or more chemicals, humidity, particulate concentration, or the like. Accordingly, the effect of the output of the air treatment source 120 can be actively or passively monitored within the enclosed space. Such monitoring allows for selective control of the generation and output of air treatment in the enclosed space based at least on the internal conditions within the enclosed space. Accordingly, if an air treatment generation or output parameter needs to be adjusted or air treatment needs to be terminated because a selected internal condition is present, the air treatment device 100 can automatically determine and execute such adjustment.

The at least one sensor 171 may be an external sensor disposed outside of the enclosed space, such as remote from or on one or more portions of the air treatment device 100 disposed outside of the enclosed space. For example and as shown in FIG. 2, the external sensor (e.g., sensor 171) may be disposed on the housing 110 of the air treatment device 100 on the back end region of the air treatment device 100. The external sensor is configured to detect environmental conditions remote from (collocated with but otherwise outside of) the enclosed space. The one or more environmental conditions may include one or more of temperature, concentration of one or more chemicals, humidity, elevation, particulate concentration, or global position. Accordingly, the external sensor may include one or more of a temperature sensor, a humidity sensor, an altimeter, a chemical sensor (e.g., an oxygen sensor), a particulate sensor, or a global positioning receiver.

Using the external sensor, the air or environmental conditions input into enclosed space, such as through the air treatment source 120, can be actively or passively monitored outside of the enclosed space. Such monitoring allows for selective control of the generation and output of air treatment in the enclosed space based at least on the environmental conditions outside of the enclosed space. Accordingly, an air treatment parameter may be adjusted based on one or more external conditions. For example, ozone production in a corona discharge generator differs in cold conditions versus hot conditions based on the effect of heat on the availability of oxygen molecules. Similarly, humidity may cause ozone to react with water in the air, thereby exhausting some of the ozone before it can react with a target within the enclosed space. In such environmental conditions is may be desirable to increase voltage in the corona discharge generator in order to produce a greater amount of ozone than would be used in dry or colder conditions. The environmental conditions provide baseline parameters for determining generation and output of the air treatment(s). Such determinations may be carried out by the controller 130, such as according to one or more look-up tables stored therein and corresponding to generation and output parameters based on one or more environmental conditions. Likewise, the altimeter and global positioning receiver may be utilized to determine a position of the sensor and corresponding air treatment device to determine environmental conditions at the position. For example, oxygen is not as plentiful at higher altitudes than at lower altitudes. In environments at higher elevations, a higher voltage in corona discharge ozone generators may be utilized to compensate for the relative reduction in available atmospheric oxygen compared to lower elevations.

In some examples, the external sensor (e.g., sensor 171) may be located on a central sensor hub in communication with the at least one air treatment device 100, such as via the corded connection 199 or a wireless connection. In such examples, a single sensor 171 or sensor hub including the same may be operably coupled to multiple air treatment devices 100.

Referring back to the memory storage medium 132, the one or more operational programs may include instructions for controlling generation and output of air treatment from the air treatment source according to one or more environmental conditions detected by the external sensor and one or more conditions detected in the enclosed space by the integrated sensor. Responsive to selected environmental conditions detected by the at least one sensor 170 and/or 171, the controller may initiate and adjust the generation and output of air treatments. For example, the operational programs may include instructions for generating and outputting the air treatment according to an output rate corresponding to the one or more environmental conditions detected by the external sensor. The operational programs may include instructions for adjusting the generation and output of the air treatment at the first air treatment rate according to the one or more conditions detected in the enclosed space by the integrated sensor.

The one or more operational programs may include instructions for generating and outputting an amount of air treatment based on an expected effect of the air treatment on one or more goods or objects in the enclosed space. For example, where the objects in an enclosed space include fruit or vegetables, the one or more operational programs may include instructions for outputting an amount of ozone effective to eliminate at least 90% of ethylene present in the enclosed space, or at least 20%, 20%-99%, 20%-50%, 50% to 70%, 70%-99%, at least 50%, at least 70% or less than 99% of the ethylene in the enclosed space. In such examples, ripening of the fruit or vegetables may be selectively controlled by the air treatment. Other chemicals in the enclosed space can be controlled similarly to ethylene, such as oxygen, other alcohols, or the like.

Accordingly, the air treatments disclosed herein may be used to selectively control the state of goods or objects in the enclosed space. For example, state of the goods or objects may include one or more of ripeness, spoilage, bacterial presence, fungal presence, or threshold levels of any of the foregoing. Outputting ozone, dehumidifying, or cooling may prevent or at least partially eliminate bacteria or bacterial and/or fungal growth on goods or objects in the enclosed space. The one or more operational programs may include instructions for adjusting or ceasing air treatment generation and output if the internal sensing signal indicates that an internal condition has been met or exceeded, such as a temperature, a humidity level, a chemical concentration, or a treatment time has been met.

The circuitry 180 includes circuitry connecting the components of the air treatment device 100, such as wires, circuits, circuit boards, or the like. The circuitry 180 includes power supply circuitry and data communication circuitry.

The air treatment device 100 may include remote control 190. The remote control 190 is in wireless communication with one or more of the controller 130 or the communication hub 140. The remote control 190 is configured to control one or more functions or operations of the air treatment device 100. The one or more of buttons or receiver are configured to send one or more signals to the controller 130, such as to activate, adjust, or deactivate the air treatment device 100.

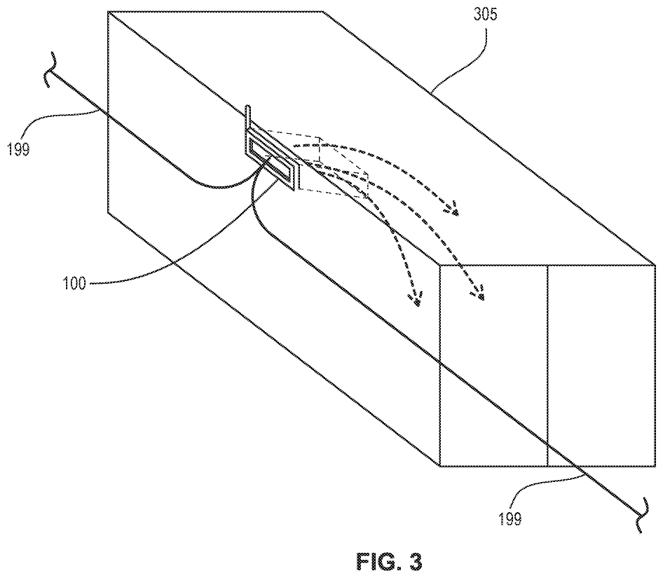

FIG. 3 is an isometric view of an enclosed space 305 having an air treatment device 100 disclosed therein, according to an embodiment. As shown, the air treatment device 100 may be positioned on or in the enclosed space 305 (e.g., at least partially within) to provide the air treatment into the enclosed space 305. While the enclosed space 305 is illustrated as a cargo container, enclosed spaces 305 may include one or more of cargo containers, train cars, truck trailers, hotel rooms, cruise ship rooms, hospital rooms, school rooms, offices, or the like. The walls, floor, and ceiling of the one or more of cargo containers, train cars, truck trailers, hotel rooms, cruise ship rooms, hospital rooms, school rooms, offices, or the like, at least partially defines the volume of the enclosed space(s) 305. The enclosed space 305 includes the enclosure defining the enclosed space 305.

One or more goods or objects within the enclosed space 305 may be treated or otherwise affected by the air treatment output into the enclosed space 305. For example, fruit or vegetables in a cargo container can be prevented from ripening by output of ozone into the air in the cargo container to react with ethylene therein. Objects in offices, hotel rooms, or hospitals can be treated to eliminate or reduce bacteria, fungi, or viruses by emission of ozone thereon. The environmental conditions and internal conditions around and in the enclosed space are used to selectively control the rate of generation and output of air treatment such that the correct amount of air treatment is applied in the enclosed space. For example, it may be undesirable to output too much ozone into an enclosed space because ozone can degrade some materials, so selective control of the generation and output of ozone using the at least one sensor can prevent such overexposure to ozone and closely controls the state of a good or object in the enclosed space. The state of the good or object may include one or more of ripeness, spoilage, bacterial presence, fungal presence, moisture content, surface oxidation, or threshold levels of any of the foregoing. The selective control of generation and output of air treatment also conserves electricity.

The air treatment device 100 may be disposed on or in the enclosed space 305. For example, the enclosed space 305 may include a port, a fixture, a stand, a vent, or other enclosed or captured environment to allow the air treatment device or air treatment to be input into the enclosed space 305. The front of the air treatment device 100 may be disposed in the enclosed space 305 such that the outlet port of the air treatment device 100 is positioned to output the air treatment into the enclosed space. One or more portions of the air treatment device 100 may be fluidly connected to the environment outside of the enclosed space 305. For example, the back end region of the air treatment device 100 may be exposed to the environment outside of the enclosed space 305. An air intake may be located on the back end region of the air treatment device 100 to draw air from the external environment into the enclosed space 305. In some examples, the air treatment device 100 may be fluidly connected to the external environment through a conduit (not shown), such as one or more vents, hoses, tubes, pipes, or other conduits for intake of air from outside of the enclosed space.

The air treatment device 100 may be operably coupled (e.g., electrically and/or electronically) to one or more of an electrical power source, a central sensor hub, or one or more additional air treatment devices. For example, the corded connection 199 may be used to provide a data connection to the air treatment devices 100. The corded connection 199 may be used to provide an electrical connection to the air treatment devices 100. The connection of one or more air treatment devices 100 forms systems for treating one or more enclosed spaces. For example, data and power may be supplied to a plurality of air treatment devices in corresponding cargo containers or other enclosed spaces to control the contents of the air therein and the state of goods or objects therein.

In some examples, the enclosed spaces may each include a corresponding air treatment device to selectively control the conditions within the enclosed spaces. This control includes control based on environmental conditions outside of the enclosed space and internal conditions within the respective enclosed spaces. Accordingly, a single set of environmental sensing data can be used to set a baseline air treatment generation and output rate for all air treatment devices while the individual sets of internal sensing data can be used to fine tune or otherwise adjust the air treatment generation and output from the individual air treatment devices based on the internal conditions of the respective enclosed spaces.

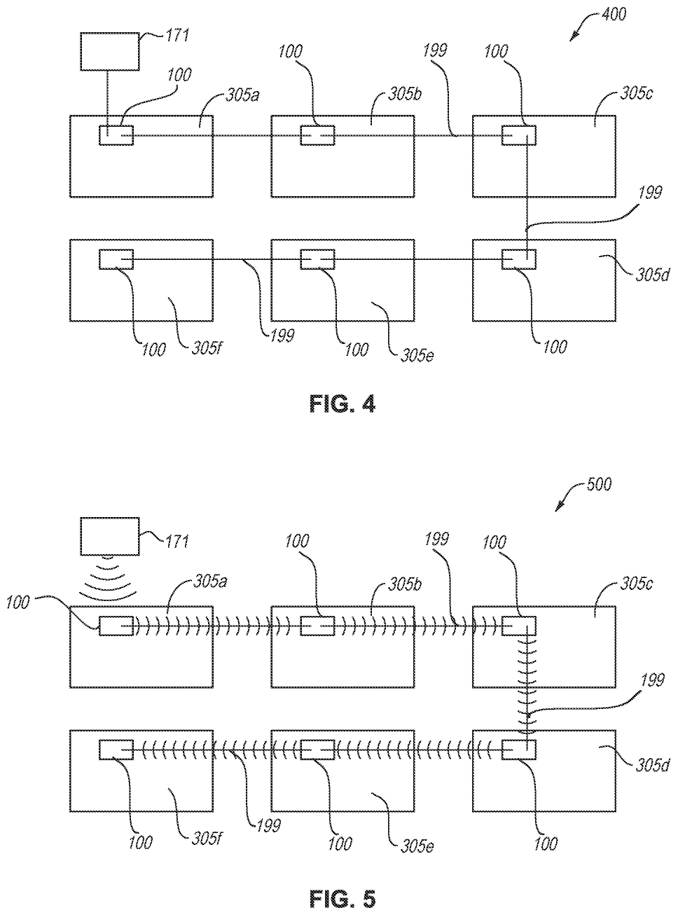

FIG. 4 is a block diagram of a system 400 for controlling contents of air within one or more enclosed spaces, according to an embodiment. The system 400 includes one or more enclosed spaces 305a-305f and one or more air treatment devices 100 disposed therein. The one or more enclosed spaces 305a-305f may include any of the enclosed spaces disclosed herein, such as enclosed space 305 (FIG. 3). The one or more air treatment devices 100 may be similar or identical to any of the air treatment devices disclosed herein, in one or more aspects. For example, the air treatment devices may include an air treatment source, a controller operably coupled to the air treatment source and configured to control output of air treatment from the air treatment source, and at least one sensor in electronic communication with the controller. The one or more air treatment sources may include one or more of an ozone generator, an ion generator, an ultraviolet light source, an anti-microbial source, a humidifier, a dehumidifier, a heater, a cooler, or an air filter.

The one or more air treatment devices 100 may include a plurality of air treatment devices 100, each disposed in separate enclosed spaces. The one or more air treatment devices 100 may be in electronic communication with a central hub (e.g., external sensor hub), such as a data connection and/or power connection via the corded connection 199. Accordingly, the one or more air treatment devices may receive environmental conditions sensed by the external sensor via one or more wired connections. Such examples are particularly useful on container ships, trains, and truck trailers to treat air therein.

The at least one sensor may include at least one integrated sensor configured to detect one or more internal conditions of an enclosed space 305a-305f in which an air treatment device of the one or more air treatment devices 100 is located. The at least one integrated sensor (not shown) may include one or more of a temperature sensor, a humidity sensor, an altimeter, an oxidant sensor, an ozone sensor, an oxygen sensor, an ethylene sensor, a particulate sensor, or a global positioning receiver. The at least one sensor may include at least one external sensor (171) disposed outside of the enclosed space 305a-305f and the at least one external sensor is configured to detect one or more environmental conditions of outside of the one or more enclosed spaces 305a-305f, such as any of the environmental sensors disclosed herein. For example, the at least one external sensor may include one or more of a temperature sensor, a humidity sensor, an altimeter, an oxygen sensor, a particulate sensor, or a global positioning receiver.

The controller includes a memory storage medium having one or more operational programs including machine readable and executable instructions for controlling generation and output of air treatment from the air treatment source and a processor operably coupled to the memory storage medium, the processor being configured to read and execute the one or more operational programs. The one or more operational programs include instructions for controlling air treatment output to selectively control a state of a good or object in the enclosed space according to the one or more environmental conditions and the one or more internal conditions. The one or more operational programs may include instructions for controlling generation and output of air treatment from an air treatment source of the one or more air treatment devices according to one or more environmental conditions detected by the at least one external sensor and one or more internal conditions detected in the enclosed space by the at least one integrated sensor. The one or more operational programs may include instructions for generating and outputting the air treatment according to an output rate corresponding to the one or more environmental conditions detected by the external sensor and instructions for adjusting the generation and output of the air treatment according to the one or more internal conditions detected in the enclosed space by the integrated sensor. For example, the one or more operational programs may include instructions to establish a baseline air treatment generation and output rate into an enclosed space based on the sensed environmental conditions and instructions to adjust the generation and output from the baseline level to at least one additional level based on the internal conditions of the enclosed space sensed by the integrated sensor.

For example, the one or more internal conditions may include one or more of temperature, humidity, or concentration of one or more chemicals and the one or more environmental conditions may include one or more of temperature, concentration of one or more chemicals, humidity, elevation, particulate concentration, or global position of the at least one sensor. The one or more operational programs may include instructions for controlling one or more temperature, oxygen concentration, ozone concentration, ethylene concentration, humidity, or particulate concentration within the enclosed space.

The operational programs may include instructions to generate and output an air treatment effective to reduce or eliminate one or more chemicals present in the enclosed space to a selected level, such as via a physical or chemical reaction to the air treatment. For example, the instructions may include instructions to eliminate at least 10% of the selected chemical, virus, bacteria, mold, or the like, such as 10% to 99%, 10% to 50%, 50% to 80%, 70% to 99%, more than 50%, more than 70%, more than 90%, or less than 99% of the selected chemical, virus, bacteria, mold, or the like. Such chemical elimination includes forming reaction products that differ from the reactants in one or more aspects, such as chemical composition. In some examples, the air treatment source includes an ozone generator and the one or more operational programs include instructions for outputting an amount of ozone effective to eliminate at least 90% of ethylene present in the enclosed space, or any of the amounts thereof disclosed herein. Furthermore, additive amounts of any other chemical or chemicals of any desired compound may be utilized to regulate ethylene at any desired level, such as no more than 90% or more than 90%, depending on the specific item being maintained in the enclosed space and depending on one or more of any internal, external, or environmental condition.

The one or more operational programs are composed to control the state of a good or objects within the enclosed spaces 305a-305f by generating and outputting air treatment therein. Such goods or objects may include any of the objects disclosed herein, such as foodstuffs. The state of the good may include one or more of ripeness, spoilage, bacterial presence, viral presence, fungal presence, or threshold levels of any of the foregoing.

The operational programs may include instructions to generate and output air treatment for a selected amount of time, at a selected rate, or of one or more selected air treatment types based on the detected environmental conditions and/or internal conditions. Based on the internal conditions detected by the integrated sensor, the operational programs include instructions to raise, lower, or terminate air treatment generation, time, rate, or to switch air treatment types. For example, cooling, air filtration, ozone generation, ion generation, or dehumidification may be individually controlled by the one or more operational programs to provide a selected effect on the state of goods or objects in the enclosed spaces 305a-305f.

While a wired connection between the sensor hub and air treatment devices is depicted in FIG. 4, a wireless data connection may be utilized. FIG. 5 is a block diagram of a system 500 for controlling contents of air within one or more enclosed spaces, according to an embodiment. The system 500 may be similar or identical to the system 400 in one or more aspects. For example, the system 500 includes one or more enclosed spaces 305a-305f and one or more air treatment devices 100 disposed therein. The one or more air treatment devices 100 may be similar or identical to any of the air treatment devices disclosed herein, in one or more aspects, such as components, operational programs, or configurations.

As shown, the at least one sensor 171 (e.g., external sensor) may be wirelessly connected to one or more air treatment devices 100 on the enclosed spaces 305a-305f, either directly or indirectly. In such examples, the environmental sensing data may be communicated to the air treatment devices via a wireless signal. In such examples, the air treatment devices 100 may be configured to wirelessly receive and propagate the wireless signals to others of the air treatment devices 100, such as via Bluetooth, Wi-Fi, infrared, radio, or any other suitable wireless signal for communicating data.

In some examples, each air treatment device 100 may receive the environmental data (e.g., sensing data) directly from the sensor hub (e.g., eternal sensor(s) of the at least one sensor 170) via a wireless signal therebetween.

The corded connection 199 may be utilized to provide power to the air treatment devices 100. In such examples the corded connection 199 may not include a data connection.

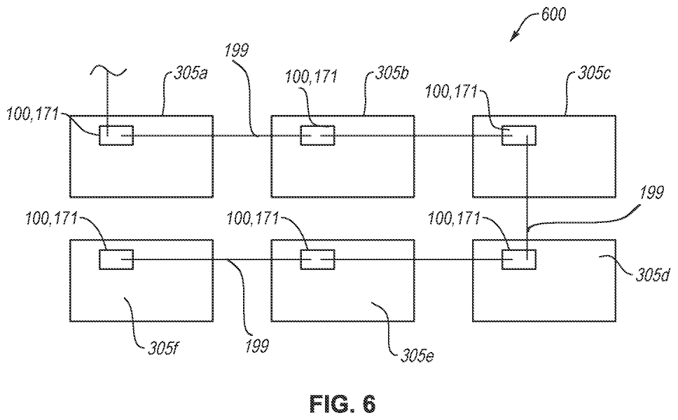

In some examples, systems include one or more of the air treatment devices having external sensors thereon. FIG. 6 is a block diagram of a system 600 for controlling contents of air within one or more enclosed spaces, according to an embodiment. The system 600 may be similar or identical to the system 500 or 400 in one or more aspects. For example, the system 600 includes one or more enclosed spaces 305a-305f and one or more air treatment devices 100 disposed therein. The one or more air treatment devices 100 may be similar or identical to any of the air treatment devices disclosed herein, in one or more aspects, such as components, operational programs, or configurations.

As shown, the at least one sensor 171 (e.g., external sensor) may be disposed on the one or more air treatment devices 100 on or in the enclosed spaces 305a-305f. In such examples, the environmental sensing data may be collected on at least one of the air treatment devices 100 on the enclosed spaces 305a-305f, such as each air treatment device 100. In such examples, the air treatment devices 100 may be configured to wirelessly receive and propagate the wireless signals to others of the air treatment devices 100, such as via Bluetooth, Wi-Fi, infrared, radio, or any other suitable wireless signal for communicating data.

In some examples, each air treatment device 100 may receive the environmental data (e.g., sensing data) directly from the sensor hub (e.g., eternal sensor(s) of the at least one sensor 170) via a wireless signal therebetween.

The corded connection 199 may be equipped to and utilized to communicated data to the air treatment devices 100. The corded connection 199 may be utilized to provide power to the air treatment devices 100. In some examples the corded connection 199 may not include a data connection.

While six enclosed spaces are depicted in FIGS. 4-6, more or fewer enclosed spaces and air treatment devices may be utilized in systems. For example, systems may include at least 1 enclosed space and corresponding air treatment device, such as 1-100 enclosed spaces and air treatment devices, 1-10, 10-20, 20-50, 50-100, 100-1000, less than 1000, less than 500, less than 100, or more than 10 enclosed spaces and corresponding air treatment devices.

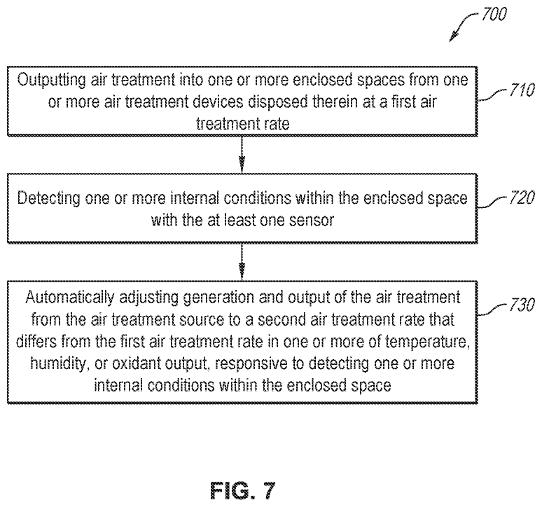

FIG. 7 is a flow diagram of a method for controlling contents of air in one or more enclosed spaces, according to an embodiment. The method 700 includes block 710 of outputting air treatment into one or more enclosed spaces from one or more air treatment devices disposed therein at a first air treatment rate; a block 720 of detecting one or more internal conditions within the enclosed space with the at least one sensor; and a block 730 of automatically adjusting generation and output of the air treatment from the air treatment source to a second air treatment rate that differs from the first air treatment rate in one or more of temperature, humidity, or oxidant output, responsive to detecting one or more internal conditions within the enclosed space. In some examples, one or more of the blocks 710-730 may be combined into one block or split into multiple blocks. For example, the block of automatically adjusting generation and output of air treatment may be split into multiple blocks of determining a second air treatment rate based on the internal conditions and implementing the second air treatment rate. In some examples additional blocks may be utilized in the method 700.

The block 710 of outputting air treatment into one or more enclosed spaces from one or more air treatment devices disposed therein at a first air treatment rate may include utilizing any of the air treatment devices disclosed herein, such as air treatment device 100 (FIGS. 1 and 2). For example at least some (e.g., each) of the one or more air treatment devices may include an air treatment source, a controller operably coupled to the air treatment source and configured to control output of air treatment from the air treatment source, and at least one sensor in electronic communication with the controller, the at least one sensor being configured to detect one or more of temperature, humidity, or concentration of one or more chemicals in an area near or immediately surrounding an air treatment device of the one or more air treatment devices. The controller may include a memory storage medium having one or more operational programs including machine readable and executable instructions for controlling generation and output of air treatment from the air treatment source, and a processor operably coupled to the memory storage medium, the processor being configured to read and execute the one or more operational programs. The one or more operational programs may include instructions for controlling air treatment generation and output to selectively control a state of a good in an enclosed space of the one or more enclosed spaces. Operational programs include machine readable and executable instructions for automatically performing any of the acts disclosed herein.

The air treatment source may include any of the air treatment sources disclosed herein, such as one or more of an ozone generator, an ion generator, an ultraviolet light source, an anti-microbial source, a humidifier, a dehumidifier, a heater, a cooler, or an air filter. Accordingly, outputting the air treatment may include outputting one or more of ozone, oxidants, ions, humidity, dehumidifying, cool air, heat, filtered air, or the like.

The at least one sensor may include any of the sensors disclosed herein. The at least one sensor may be configured to detect one or more of humidity, temperature, concentration of one or more chemicals, particulates, location of the sensor, altitude of the sensor, or any other condition disclosed herein. The at least one sensor may include one or more of at least one external sensor or at least one integrated sensor. The at least one external sensor may be in electronic communication with the controller of the one or more air treatment devices and disposed outside of the one or more enclosed spaces, the at least one external sensor may be configured to detect one or more environmental conditions outside of the one or more enclosed spaces. The at least one integrated sensor may be configured to detect the internal conditions of the enclosed space in which an air treatment device is located.

Outputting air treatment into one or more enclosed spaces from one or more air treatment devices disposed therein at a first air treatment rate may include outputting any of the air treatments disclosed herein from any of the air treatment sources disclosed herein. For example, outputting air treatment into one or more enclosed spaces from one or more air treatment devices disposed therein at a first air treatment rate may include one or more of outputting ozone from an ozone generator, ions from an ion generator, oxidant from an oxidant generator, cold air from a cooler, heat from a heater, humidified air from a humidifier, dehumidified air form a dehumidifier, filtered air form an air filter, at the first air treatment rate. Outputting air treatment into one or more enclosed spaces may include outputting the air treatment into any of the enclosed spaces disclosed herein. For example, the enclosed spaces may include one or more of cargo containers, train cars, truck trailers, hotel rooms, cruise ship rooms, hospital rooms, school rooms, offices, or the like. Outputting air treatment into one or more enclosed spaces from one or more air treatment devices disposed therein may include outputting air treatment into a plurality of enclosed spaces with a plurality of air treatment devices.

Outputting the air treatment into one or more enclosed spaces from the one or more air treatment devices may include outputting the air treatment at a rate determined based at least in part upon the environmental sensing data. The one or more operational programs may include instructions for activating a selected air treatment source at the first air treatment rate responsive to environmental sensing data, such as to compensate for environmental conditions indicated by the environmental sensing data. The first air treatment rate may correspond to an amount of atmospheric oxygen available in an environment surrounding the one or more enclosed spaces. For example, high temperatures at a selected location may indicate a relatively lower amount (e.g., density) of oxygen in the environment compared to cooler temperatures, and the operational programs may include instructions for using a relatively higher voltage in corona discharge generator for a selected duration to form ozone at an acceptable rate due to the relative lack of atmospheric oxygen for conversion to ozone. The one or more operational programs may include instructions to operate any of the components of the air treatment device at selected parameters, such as generation rates (e.g., ozone generation, heating, cooling, humidity, dehumidification, filtration), output rates (e.g., fan speed to intake and/or output air and air treatment), durations of the foregoing, and types of air treatment outputs.

The first air treatment rate (and second air treatment rate) of the operational programs may be formulated to selectively control a state of a good or object in the enclosed space, such as to prevent ripening, sanitize objects, prevent contamination, or the like. The instructions in the operational programs may include instructions to eliminate at least 10% of a selected chemical, virus, bacteria, mold, or the like, such as 10% to 99%, 10% to 50%, 50% to 80%, 70% to 99%, more than 50%, more than 70%, more than 90%, or less than 99% of the selected chemical, virus, bacteria, mold, or the like. For example, the first air treatment rate may be a generation and output rate selected to eliminate at least 90% of ethylene in the enclosed space based at least in part on availability of atmospheric oxygen. The instructions in the operational programs may include instructions to heat or cool the temperature in the enclosed space(s) by a selected amount, such as to reach a target temperature. The instructions in the operational programs may include instructions to raise or lower the humidity in the enclosed space(s) by a selected amount, such as to reach a target humidity. Accordingly, the air treatment(s) may be output at a rate selected to control the state of a good or object in the enclosed space.

The block 720 of detecting one or more internal conditions within the enclosed space with the at least one sensor may include detecting one or more of humidity, temperature, concentration of one or more chemicals, or particulates in the enclosed space. For example, detecting one or more internal conditions within the enclosed space may include detecting a concentration of one or more of oxygen, ozone, ethylene in the enclosed space. The internal sensor may include any of the sensors disclosed herein, such as one or more of a temperature sensor, a humidity sensor, an altimeter, an oxidant sensor, an ozone sensor, an oxygen sensor, an ethylene sensor, a particulate sensor, or a global positioning receiver.

Detecting one or more internal conditions within the enclosed space may include be carried out at initialization of air treatment, periodically, or constantly. The controller of the air treatment device may instruct the internal sensor when to sense the one or more internal conditions, such as based on an operational program having instructions for performing the same. The method 700 may include communicating the internal conditions from the at least one sensor to the controller.

The block 730 of automatically adjusting generation and output of the air treatment from the air treatment source to a second air treatment rate that differs from the first air treatment rate in amounts of one or more of temperature, humidity, or oxidant output, responsive to detecting one or more internal conditions within the enclosed space may include raising, lowering, or terminating generation and output of the air treatment from the air treatment source. For example, automatically adjusting generation and output of the air treatment from the air treatment source to a second air treatment rate that differs from the first air treatment rate may include increasing or decreasing generation and output of one or more of oxidant (e.g., ozone), heating, cooling, or humidity, responsive to detecting the one or more internal conditions within the enclosed space. Automatically adjusting generation and output of the air treatment from the air treatment source to a second air treatment rate that differs from the first air treatment rate may include terminating generation and output of one or more of oxidant, ozone, heating, cooling, or humidity.

In some examples, automatically adjusting generation and output of the air treatment from the air treatment source to a second air treatment rate may include changing (e.g., adding or terminating) the air treatment type. For example, humidity may be added where ozone production was the only air treatment of the first air treatment rate. In such examples, water (humidity) may react with ozone to deactivate the ozone in the enclosed space.

Automatically adjusting generation and output of the air treatment from the air treatment source to a second air treatment rate may be carried out according to one or more operational programs having instructions to adjust the generation and output of air treatment to the second air treatment rate. The instructions may include instructions to determine the second air treatment rate based at least in part on the internal conditions.

The one or more operational programs may include instructions to read look-up tables stored in the memory storage to determine what internal conditions would maintain or change the state of a good or object within the enclosed space, such as one or more of temperature, humidity, chemical output, or air circulation in the enclosed space. Responsive thereto, the operational program may include instructions to determine target conditions within the enclosed space and an (second) air treatment rate to reach the target conditions. The operational program may include instructions to adjust air treatment generation and output from the first air treatment rate to the second air treatment rate.

In some examples, the second air treatment rate does not differ from the first air treatment rate. In such examples, the air treatment may be maintained for a selected duration.

In some examples, the method 700 includes receiving external sensing signals or data from the at least one external sensor. For example, the method 700 may include receiving external sensing signals indicating the one or more environment conditions outside of the enclosed space from the at least one external sensor with the controller. The method 700 may include determining and setting the first air treatment rate based at least partially on the external sensing signals, such as automatically, with the controller, responsive to receiving the external sensing signals. Determining the first air treatment rate may be carried out substantially similarly or identically to determining the second air treatment rate as described above. For example, the environmental conditions determined from the external sensing signals may include conditions that effect the amount or density of oxygen in the environment around the enclosed spaces and the first treatment rate may be selected based on availability of atmospheric oxygen, such as to generate and output a selected amount of ozone. Similarly, humidity output rates may be adjusted based on relative humidity.

The at least one external sensor may be located remotely from at least one of the air treatment devices, such as in a central sensor hub or another of the one or more air treatment devices. The central sensor hub may be used to provide sensing signals to a plurality of air treatment devices. Accordingly, a single sensor or set of sensors may be used to provide baseline conditions for the first air treatment rate. In some examples, the air treatment (and corresponding operational programs) may be based solely on the environmental conditions detected by the external sensor.

The operational programs may include machine readable and executable instructions for performing any of the acts disclosed herein. The operational programs may include instructions for monitoring conditions with the at least one sensor continuously or periodically to provide real time monitoring of conditions (e.g., environmental and internal) and adjustment of generation and output of air treatments. For example, the environmental conditions may change during air treatment and the air treatment rates may be changed to correspond to the most recent environmental conditions. Likewise, the internal conditions may change during air treatment and the air treatment rates may be changed to correspond to the most recent internal conditions.

The air treatment devices, systems, and methods disclosed herein provide high efficiency, remote sensor based treatment of enclosed spaces to control the state of one or more goods in the enclosed spaces. By selectively controlling the air treatment rates based on environmental and internal conditions, the air treatments can effectively treat the enclosed spaces and goods therein to place the goods in a selected state, such as ripeness, cleanliness, freshness, or the like more than similar devices, systems, and methods that do not include the sensor based control disclosed herein. The sensor based control of air treatment rates disclosed herein provides initial control based on conditions outside of the enclosed space and control based on internal conditions in the enclosed space. Accordingly, more than one set of inputs can be used in air treatments, based inputs and outputs of the devices, systems, and methods disclosed herein.

As used herein, the term “about” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

What is claimed is:

1. A device for controlling contents of air in an enclosed space, the device comprising:
an air treatment source;
a controller operably coupled to the air treatment source and configured to control output of air treatment from the air treatment source, the controller including,
a memory storage medium having one or more operational programs including machine readable and executable instructions for controlling generation and output of air treatment from the air treatment source; and
a processor operably coupled to the memory storage medium, the processor being configured to read and execute the one or more operational programs;
at least one sensor in electronic communication with the controller, the at least one sensor being configured to detect one or more of temperature, humidity, or concentration of one or more chemicals in an area near or immediately surrounding the device;
wherein the one or more operational programs include instructions for controlling air treatment output to selectively control a state of a good in the enclosed space.

2. The device of claim 1 wherein the air treatment source includes one or more of an ozone generator, an ion generator, an ultraviolet light source, an anti-microbial source, a humidifier, a dehumidifier, a heater, a cooler, or an air filter.

3. The device of claim 1 wherein the one or more operational programs include instructions for controlling one or more temperature, oxygen concentration, ozone concentration, ethylene concentration, humidity, or particulate concentration within the enclosed space.

4. The device of claim 1 wherein the at least one sensor includes one or more of a temperature sensor, a humidity sensor, an altimeter, an oxidant sensor, an ozone sensor, an oxygen sensor, an ethylene sensor, a particulate sensor, or a global positioning receiver.

5. The device of claim 1 wherein the at least one sensor includes one or more of an external sensor remotely located remotely from the enclosed space or an integrated sensor disposed in the enclosed space.

6. The device of claim 5 wherein the external sensor is remote from the device and the integrated sensor is disposed on the device.

7. The device of claim 5 wherein the one or more operational programs include instructions for controlling generation and output of air treatment from the air treatment source according to one or more environmental conditions detected by the external sensor and one or more conditions detected in the enclosed space by the integrated sensor.

8. The device of claim 7 wherein the one or more operational programs include instructions for:
generating and outputting the air treatment according to an output rate corresponding to the one or more environmental conditions detected by the external sensor; and
adjusting the generation and output of the air treatment according to the one or more conditions detected in the enclosed space by the integrated sensor.

9. The device of claim 1 wherein:
the air treatment source includes an ozone generator; and
the one or more operational programs include instructions for outputting an amount of ozone effective to eliminate at least 90% of ethylene present in the enclosed space.

10. The device of claim 1 wherein the state of the good includes one or more of ripeness, spoilage, bacterial presence, fungal presence, or threshold levels of any of the foregoing.

11. A system for controlling contents of air within one or more enclosed spaces, the system comprising:
one or more air treatment devices, the one or more air treatment devices including:
an air treatment source;
a controller operably coupled to the air treatment source and configured to control output of air treatment from the air treatment source, the controller including,
a memory storage medium having one or more operational programs including machine readable and executable instructions for controlling generation and output of air treatment from the air treatment source; and
a processor operably coupled to the memory storage medium, the processor being configured to read and execute the one or more operational programs;
at least one integrated sensor in electronic communication with the controller, the at least one integrated sensor being configured to detect one or more internal conditions of an enclosed space in which an air treatment device of the one or more air treatment devices is located; and
at least one external sensor in electronic communication with the controller of the air treatment device and disposed outside of the enclosed space, the at least one external sensor being configured to detect one or more environmental conditions of outside of the one or more enclosed spaces;
wherein the one or more operational programs include instructions for controlling air treatment output to selectively control a state of a good in the enclosed space according to the one or more environmental conditions and the one or more internal conditions.

12. The system of claim 11 wherein the one or more air treatment sources includes one or more of an ozone generator, an ion generator, an ultraviolet light source, an anti-microbial source, a humidifier, a dehumidifier, a heater, a cooler, or an air filter.

13. The system of claim 11 wherein the one or more operational programs include instructions for controlling one or more temperature, oxygen concentration, ozone concentration, ethylene concentration, humidity, or particulate concentration within the enclosed space.

14. The system of claim 11 wherein the at least one external sensor includes one or more of a temperature sensor, a humidity sensor, an altimeter, an oxygen sensor, a particulate sensor, or a global positioning receiver.

15. The system of claim 11 wherein the at least one integrated sensor includes one or more of a temperature sensor, a humidity sensor, an altimeter, an oxidant sensor, an ozone sensor, an oxygen sensor, an ethylene sensor, a particulate sensor, or a global positioning receiver.

16. The system of claim 11 wherein the one or more operational programs include instructions for controlling generation and output of air treatment from an air treatment source of the one or more air treatment devices according to one or more environmental conditions detected by the at least one external sensor and one or more internal conditions detected in the enclosed space by the at least one integrated sensor.

17. The system of claim 11 wherein the one or more operational programs include instructions for:
generating and outputting the air treatment according to an output rate corresponding to the one or more environmental conditions detected by the external sensor; and
adjusting the generation and output of the air treatment according to the one or more internal conditions detected in the enclosed space by the integrated sensor.

18. The system of claim 17 wherein:
the one or more internal conditions include one or more of temperature, humidity, or concentration of one or more chemicals; and
the one or more environmental conditions include one or more of temperature, concentration of one or more chemicals, humidity, elevation, particulate concentration, or global position.

19. The system of claim 11 wherein:
the air treatment source includes an ozone generator; and
the one or more operational programs include instructions for outputting an amount of ozone effective to eliminate at least 90% of ethylene present in the enclosed space.

20. The system of claim 11 wherein the state of the good includes one or more of ripeness, spoilage, bacterial presence, fungal presence, or threshold levels of any of the foregoing.

21. The system of claim 11 wherein the one or more air treatment devices include a plurality of air treatment devices each disposed in separate enclosed spaces.

22. The system of claim 21 wherein the enclosed spaces include one or more of cargo containers, train cars, truck trailers, hotel rooms, cruise ship rooms, hospital rooms, school rooms, or offices.

23. A method of controlling contents of air in one or more enclosed spaces, the method comprising:
outputting air treatment into one or more enclosed spaces from one or more air treatment devices disposed therein at a first air treatment rate, each of the one or more air treatment devices including:
an air treatment source;
a controller operably coupled to the air treatment source and configured to control output of air treatment from the air treatment source, the controller including,
a memory storage medium having one or more operational programs including machine readable and executable instructions for controlling generation and output of air treatment from the air treatment source; and
a processor operably coupled to the memory storage medium, the processor being configured to read and execute the one or more operational programs;
at least one sensor in electronic communication with the controller, the at least one sensor being configured to detect one or more of temperature, humidity, or concentration of one or more chemicals in an area near or immediately surrounding an air treatment device of the one or more air treatment devices;
wherein the one or more operational programs include instructions for controlling air treatment output to selectively control a state of a good in an enclosed space of the one or more enclosed spaces;
detecting one or more internal conditions within the enclosed space with the at least one sensor;
automatically adjusting generation and output of the air treatment from the air treatment source to a second air treatment rate that differs from the first air treatment rate in one or more of temperature, humidity, or oxidant output, responsive to detecting one or more internal conditions within the enclosed space.

24. The method of claim 23 wherein outputting air treatment into one or more enclosed spaces from one or more air treatment devices disposed therein at a first air treatment rate includes outputting ozone from an ozone generator at the first air treatment rate.

25. The method of claim 24 wherein the first air treatment rate corresponds to an amount of atmospheric oxygen available in an environment surrounding the one or more enclosed spaces.

26. The method of claim 24 wherein the first air treatment rate is a rate selected to eliminate at least 90% of ethylene in the enclosed space based at least in part on availability of atmospheric oxygen.

27. The method of claim 23 wherein the air treatment source includes one or more of an ozone generator, an ion generator, an ultraviolet light source, an anti-microbial source, a humidifier, a dehumidifier, a heater, a cooler, or an air filter.

28. The method of claim 23 wherein the at least one sensor includes one or more of:
at least one external sensor in electronic communication with the controller of the one or more air treatment devices and disposed outside of the one or more enclosed spaces, the at least one external sensor being configured to detect one or more environmental conditions outside of the one or more enclosed spaces; or
at least one integrated sensor being configured to detect the internal conditions of the enclosed space in which an air treatment device is located.

29. The method of claim 28 wherein detecting one or more internal conditions within the enclosed space with the at least one sensor includes detecting one or more of humidity, temperature, concentration of one or more chemicals, or particulates in the enclosed space.

30. The method of claim 29 wherein detecting one or more internal conditions within the enclosed space include detecting a concentration of one or more of oxygen, ozone, ethylene in the enclosed space.

31. The method of claim 28, further comprising:
with the controller, receiving external sensing signals indicating the one or more environment conditions from the at least one external sensor; and
with the controller, automatically determining and setting the first air treatment rate based at least partially on the external sensing signals.

32. The method of claim 28 wherein the at least one external sensor is located in a central sensor hub or another of the one or more air treatment devices.

33. The method of claim 23 wherein automatically adjusting generation and output of the air treatment from the air treatment source to a second air treatment rate that differs from the first air treatment rate includes terminating generation and output of one or more of oxidant, ozone, heating, cooling, or humidity.

34. The method of claim 23 wherein automatically adjusting generation and output of the air treatment from the air treatment source to a second air treatment rate that differs from the first air treatment rate includes increasing or decreasing generation and output of one or more of oxidant, ozone, heating, cooling, or humidity, responsive to detecting the one or more internal conditions within the enclosed space.

35. The method of claim 23 wherein outputting air treatment into one or more enclosed spaces from one or more air treatment devices disposed therein includes outputting air treatment into a plurality of enclosed spaces with a plurality of air treatment devices.

36. The method of claim 35 wherein the plurality of enclosed spaces includes one or more of cargo containers, train cars, truck trailers, hotel rooms, cruise ship rooms, hospital rooms, school rooms, or offices.

37. The method of claim 23 wherein:
the air treatment source includes an ozone generator; and
the one or more operational programs include instructions for outputting an amount of ozone effective to eliminate at least 90% of ethylene present in the enclosed space.
